(19) United States
(12) Patent Application Publication
(10) Pub. No.: US 2013/0118649 A1
(43) Pub. Date: May 16, 2013

(54) METHOD FOR MANUFACTURING SPRING

(71) Applicants: Yuichi Hirata, Nagoya-shi (JP); Yoshitaka Ukei, Nagoya-shi (JP); Hidekazu Suzuki, Nagoya-shi (JP)

(72) Inventors: Yuichi Hirata, Nagoya-shi (JP); Yoshitaka Ukei, Nagoya-shi (JP); Hidekazu Suzuki, Nagoya-shi (JP)

(73) Assignee: CHUO HATSUJO KABUSHIKI KAISHA, Nagoya-shi (JP)

(21) Appl. No.: 13/636,274

(22) PCT Filed: Mar. 15, 2011
(86) PCT No.: PCT/JP2011/056051

§ 371 Date: Sep. 20, 2012

(30) Foreign Application Priority Data
Mar. 23, 2010 (JP) 2010-065507

(51) Int. Cl. C21D 9/02; B05D 3/02

(52) U.S. Cl. CPC C21D 9/02; B05D 3/0218
USPC 148/537

(57) ABSTRACT

A method for simultaneously annealing and applying a coating to a spring includes heating the spring up to a predetermined temperature that exceeds an upper limit of a permissible baking temperature range of the coating. The surface temperature of the spring then allowed to decrease to within the permissible baking temperature range of the coating, and then the coating is applied to a surface of the spring. The coating is then baked onto the surface of the spring while cooling the spring for at least a portion of the baking step. The heating and baking steps together achieve a predetermined low temperature annealing effect in the spring.

### TECHNICAL FIELD

The present application relates to a method for manufacturing a spring. More specifically, the present application relates to a technology for reducing the time required for a coating step that coats a surface of a spring.

### DESCRIPTION OF RELATED ART

A spring is subjected to a process for increasing durability (e.g., a shot peening process) because the spring fatigues due to cyclical loading. Also, paint is applied to the surface of the spring in order to prevent shortening of its service life or deterioration of its characteristics caused by corrosion. For these reasons, in a conventional method for manufacturing a spring, a process for increasing the durability of the spring (e.g., shot peening) is first performed, then paint is sprayed onto a surface of the spring, and finally the sprayed paint is baked onto the spring (Maruzen, Co., Ltd. “Spring,” 4^{th} edition, P. 522-530, Japan Society of Spring Engineers).

### BRIEF SUMMARY OF INVENTION

### Technical Problem

When a shot peening process or other process for increasing durability is performed on a spring, because the setting of the spring increases, it is preferred to perform a heat treatment process for preventing spring setting. For this purpose, it is conceivable to attempt to shorten the process by combining a heat treatment process for baking the sprayed paint onto the surface of the spring (i.e. a baking process) with a heat treatment process for preventing spring setting (i.e. a low temperature annealing treatment subsequent to a shot peening process (hereinafter, “low temperature annealing treatment”)).

However, the paint to be sprayed onto the surface of the spring has a particular baking coating temperature range, and the baking process must be carried out within that temperature range. Therefore, if the baking process and the low temperature annealing treatment are combined, the temperature during the treatment is limited to the baking coating temperature range of the paint. The baking coating temperature range is usually lower than the temperature that is appropriate for the low temperature annealing treatment. Therefore, the problem is that, if the baking process is combined with the low temperature annealing treatment, the length of time required for the heat treatment processes becomes long.

The present application is intended to provide a technology capable of combining the baking process and the low temperature annealing treatment and thus reducing the time required for performing these processes.

### Solution to the Technical Problem

A method for manufacturing a spring, which is disclosed in the present specification, comprises: a heating step that heats the spring up to a pre-set, predetermined temperature; and a coating step that bakes a paint sprayed onto a surface of the spring while cooling the heated spring according to a pre-set cooling pattern. The predetermined temperature and the predetermined cooling pattern are pre-set such that a predetermined low temperature annealing treatment is performed on the spring during the heating and coating steps.

In this manufacturing method, the spring is heated up to the predetermined temperature; the sprayed paint is baked onto the surface of the spring while the heated spring is cooled. Therefore, since the predetermined temperature that heats the spring is not limited to the baking coating temperature range of the paint, it can be heated up to a higher temperature than this temperature range and an appropriate low temperature annealing treatment can be performed on the spring. On the other hand, even if the spring is heated up to a temperature that exceeds the coating temperature range, the paint can be sprayed onto the surface of the spring after the temperature of the spring has fallen to within the coating temperature range and the surface of the spring can be suitably coated. Consequently, the heat treatment that combines the baking process and the low temperature annealing treatment can be performed within a short period of time.

According to the manufacturing method described above, it is preferred that the predetermined temperature is set within the range of 190 to 300° C. If the predetermined temperature is less than 190° C., the low temperature annealing process needs to be performed for a long period of time in order to achieve a sufficient result, otherwise the setting resistance of the spring diminishes. On the other hand, if the predetermined temperature exceeds 300° C., the low temperature annealing process is excessively performed, reducing the durability of the spring.

Further, according to the manufacturing method described above, it is preferred that the predetermined temperature exceeds an upper limit of the baking coating temperature range of the paint. By setting the predetermined temperature so that it exceeds the upper limit of the baking coating temperature range of the paint, the time until completion of the baking of the paint can be reduced.

In case the predetermined temperature exceeds the upper limit of the baking coating temperature range of the paint, the cooling rate that cools the spring is preferably set to be 0.01 to 13.00° C./sec. More preferably, the cooling rate is set to be 0.50 to 4.50° C./sec.

### BRIEF DESCRIPTION OF DRAWINGS

FIG. 1 is a flowchart showing one portion of manufacturing steps of a spring according to an exemplary embodiment;

FIG. 2 is a diagram showing upper and lower limits of a treatment time period when performing a low temperature annealing treatment at a constant temperature;

FIG. 3 is a diagram schematically showing an example of a temperature profile during steps S12 to S16;

FIG. 4 is a diagram schematically showing another example of the temperature profile;

FIG. 5 is a diagram schematically showing another example of the temperature profile; and

FIG. 6 is a diagram schematically showing another example of the temperature profile.

### DETAILED DESCRIPTION OF INVENTION

A method for manufacturing a spring according to an embodiment will be described. In the embodiment, a case of manufacturing a stabilizer bar, which is a type of a spring, will be described as an example. The stabilizer bar has a substantially straight linear part and arm parts that are provided at both ends of this linear part. When the stabilizer bar is installed in a vehicle, the arm parts on the two ends of the stabilizer bar are fixed to the right and left wheels, respectively, whereas the linear part is fixed to the vehicle body. This can reduce rolling of the vehicle body when turning, and improve the driving stability of the vehicle.

The method for manufacturing the stabilizer bar includes, first, a shaping step that shapes the stabilizer bar by bending a steel material while cold, warm, or hot, a heat treatment step that heat-treats the steel material shaped into the stabilizer bar shape, a shot peening step that shot-peens a surface of the heat treated steel material, and a painting step that paints the surface of the shot-peened steel material. Because the shaping step and the heat treatment step can be performed in the same manner as in the prior art, detail explanations thereof are omitted here. The shot peening step and the painting step will be described hereinafter in detail.

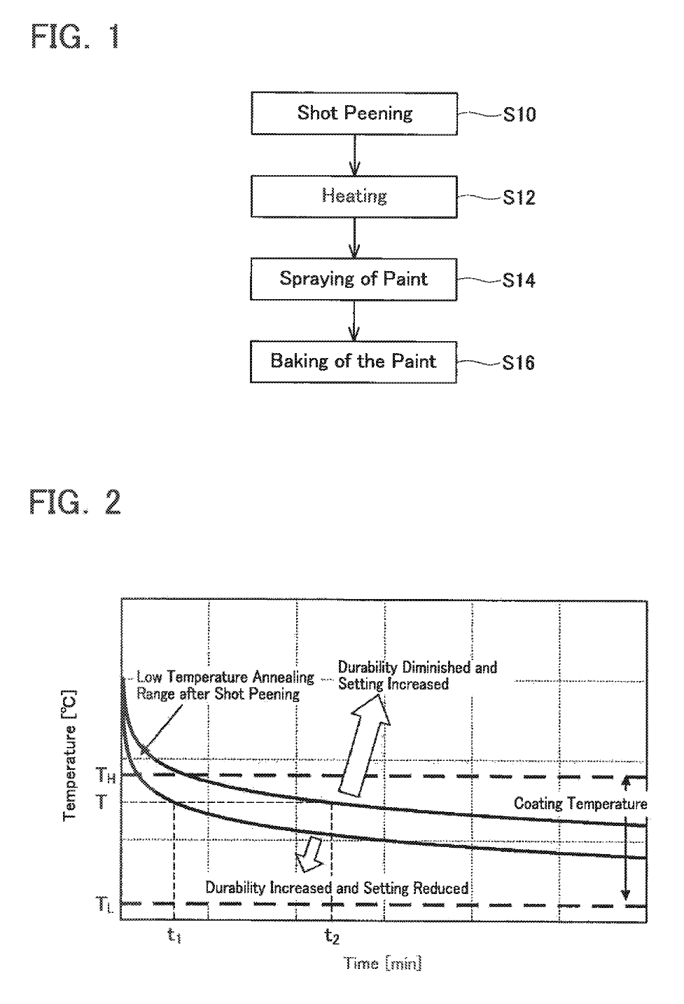

As shown in FIG. 1, first, shot peening is performed on the surface of the stabilizer bar that was heat-treated in the heat treatment step (S10). As a result, compressive residual stresses are imparted to the stabilizer bar, and an increase of the durability of the stabilizer bar is achieved. Further, surface oxide scales, which formed on the surface of the stabilizer bar in the heat treatment step that was performed subsequent to the shaping step, are removed. This can improve the paint adherence conditions. The shot peening step of step S10 can be performed in the same manner as in the prior art. In step S10, a honing process, a blasting process, or other process may be performed instead of the shot peening step.

Next, the stabilizer bar that was subjected to the shot peening step in step S10 is heated (S12). In this heating process, the surface temperature of the stabilizer bar is heated up to a pre-set, predetermined temperature. The predetermined temperature is preferably pre-set in the range of 190 to 300° C. In case the predetermined temperature is less than 190° C., if the below-described baking process of step S16 is not performed for a long period of time, the low temperature annealing treatment will be insufficient. If the low temperature annealing treatment is insufficient, the processing strain that is generated by the shot peening step in step S10 and negatively affects performance cannot be released sufficiently, and the setting resistance diminishes. On the other hand, in case the predetermined temperature exceeds 300° C., when the baking process of step S16 is completed, the low temperature annealing treatment becomes excessive. If the low temperature annealing treatment becomes excessive, too much compressive residual stress imparted to the stabilizer bar in the shot peening step of step S10 is released, and durability diminishes.

Because the heating process of step S12 is performed prior to the coating of the stabilizer bar, the predetermined temperature can be set at a temperature exceeding the upper limit of the baking coating temperature range of the paint. By heating the stabilizer bar so that it exceeds the upper limit of the baking coating temperature range of the paint in step S12, a greater effect of the low temperature annealing treatment is provided in the heating step of step S12; consequently, the time period required for completing the low temperature annealing treatment can be reduced. Furthermore, even if the predetermined temperature exceeds the upper limit of the baking coating temperature range of the paint, a problem for spraying the paint onto the surface of the stabilizer bar does not occur in the present embodiment, because the surface temperature of the stabilizer bar decreases to the baking coating temperature range.

Further, in the heating step of step S12, after the surface temperature of the stabilizer bar increases to the predetermined temperature, it may be heated so as to maintain it at its predetermined temperature for a predetermined period of time. This enables a homogenization of the surface temperature of the stabilizer bar. In this case, the period of time retaining at the predetermined temperature can be approximately 0 to 60 seconds. By setting the retaining time at 60 seconds or less, the heating step can be prevented from becoming prolonged.

Furthermore, various heating methods can be adopted as the heating step of step S12 described above. However, it is preferred to adopt a heating method capable of rapid heating in order to perform the heating step of step S12 in a short time. For example, high-speed hot air heating (wind speed: 10 m/s or higher), induction heating, infrared heating, electrical heating, etc. can be used as such a rapid heating method.

Once heating of the stabilizer bar in step S12 is finished, the paint is sprayed onto the surface of the stabilizer bar (S14). For example, in order to spray the paint, sprayed paint sprayed using high-pressure air to atomize the paint can be used. The conditions of the spray painting can be, for example, a wind speed of 0.5 to 1.0 m/min and a spraying distance of 50 to 200 mm. In the alternative, the spraying of the paint can be done by electrostatic coating. The conditions of electrostatic coating can be performed, for example, at an electric charge of 40 to 100 kV, a wind speed of 0.5 to 1.0 m/min, and an air volume of 50 to 100 m³/min. By carrying out the coating under such conditions, a coating film of uniform thickness can be formed.

Furthermore, the spraying of the paint in step S14 is performed after the surface temperature of the stabilizer bar has fallen to within the baking coating temperature range of the paint. Therefore, in case the surface temperature of the stabilizer bar exceeds the upper limit of the baking coating temperature range in step S12, the surface temperature of the stabilizer bar is cooled until it falls within the baking coating temperature range, and thereafter the paint is sprayed onto the surface of the stabilizer bar.

Once spraying of the paint onto the surface of the stabilizer bar is finished, the paint sprayed onto the surface of the stabilizer bar is then baked onto the surface of the stabilizer bar (S16). The heat applied to the stabilizer bar in the heating step of step S12 is used to bake the paint. Furthermore, in step S16, the surface temperature of the stabilizer bar is controlled to decrease in accordance with a predetermined cooling pattern. This maintains the surface temperature of the stabilizer bar within the baking coating temperature range of the paint, and the low temperature annealing treatment and the paint baking process are carried out on the stabilizer bar.

In other words, in the present embodiment, the predetermined temperature of step S12 and the cooling pattern of steps S14 and S16 are set such that a low temperature annealing treatment having an appropriate effect is performed on the stabilizer bar. That is, the low temperature annealing treatment is performed on the stabilizer bar both during the heating process of step S12 and during the coating processes of steps S14 and S16. Therefore, in case the predetermined temperature of step S12 is high, a large amount of low temperature annealing effect is imparted in step S12. This means that it is not necessary to impart much low temperature annealing effect in steps S14 and S16. Thus, the low temperature annealing effect will not become excessive by making the cooling rate of steps S14 and S16 large and/or by reducing the treatment time period of step S16. To the contrary, in case the predetermined temperature of step S12 is low, only a small amount of the low temperature annealing effect will be realized in step S12. For this reason, a large low temperature annealing effect must be realized in steps S14 and S16. Thus, by reducing the cooling rate in steps S14 and S16 and/or by lengthening the treatment time period in step S16, the low temperature annealing effect will not be insufficient.

In the present embodiment described above, the treatment time period of step S16 can be reduced by increasing the predetermined temperature of step S12. This will be described in detail with reference to FIG. 2. In FIG. 2, the upper curve indicates a maximum low temperature annealing time period obtained when the treatment temperature is constant, and the lower curve indicates a minimum low temperature annealing time period obtained when the treatment temperature is constant. The temperature T_{H} indicates a maximum baking coating temperature, and the temperature T_{L} indicates a minimum baking coating temperature. For example, when the treatment temperature for the low temperature annealing process is T, the maximum low temperature annealing time period is t₂ and the minimum low temperature annealing time period is t₁. In other words, when the treatment temperature for the low temperature annealing process is T, the treatment time period must be within the range of t₁ to t₂. If the treatment time period exceeds t₂, an excessive low temperature annealing effect is realized, which increases the setting resistance of the stabilizer bar but diminishes the durability of the stabilizer bar. On the other hand, if the treatment time period is less than t₁, the low temperature annealing effect becomes insufficient, which increases the durability of the stabilizer bar but diminishes the setting resistance of the stabilizer bar. As is clear from FIG. 2, the higher the treatment temperature is, the shorter the time period required for the low temperature annealing treatment. Especially at temperatures exceeding the upper limit T_{H} (e.g., 240° C.) of the baking coating temperature range, the desired low temperature annealing effect can be realized within an extremely short period of time. Therefore, by increasing the predetermined temperature of step S12, a large low temperature annealing effect can be provided in step S12 and the treatment time periods of steps S14 and S16 can be reduced.

Furthermore, because the paint must be baked onto the surface of the stabilizer bar in step S16, the surface temperature of the stabilizer bar is within the baking coating temperature range of the paint only for the period of time required for baking the paint. Therefore, the upper limit of the cooling rate can be determined from the time period required for completing the baking process. For example, in case the surface temperature of the stabilizer bar decreases according to a linear function, when the baking coating temperature range is 240 to 160° C. and the baking time period is 20 minutes, the maximum cooling rate is 80° C./20 minutes (i.e., 240° C./hr). Therefore, the cooling rate is determined to be less than 240° C./hr.

Moreover, the cooling rate of the stabilizer bar in step S16 can be controlled by, for example, disposing the stabilizer bar in a hot-blast stove and adjusting the temperature of the hot air supplied to the hot-blast stove. In this case, it is preferred that the cooling rate for cooling the stabilizer bar is 0.01 to 13.00° C./sec. When the cooling rate is less than 0.01° C./sec, the treatment time period of the low temperature annealing process becomes longer. On the other hand, when the cooling rate is higher than 13.00° C./sec, it becomes difficult to sufficiently ensure the baking time period. From the perspective of improving the coating quality, it is preferred that the cooling rate is 0.50 to 4.50° C./sec. By performing the coating process within this cooling rate range, variations of the surface temperature during the coating process can be limited to a substantially problem-free range.

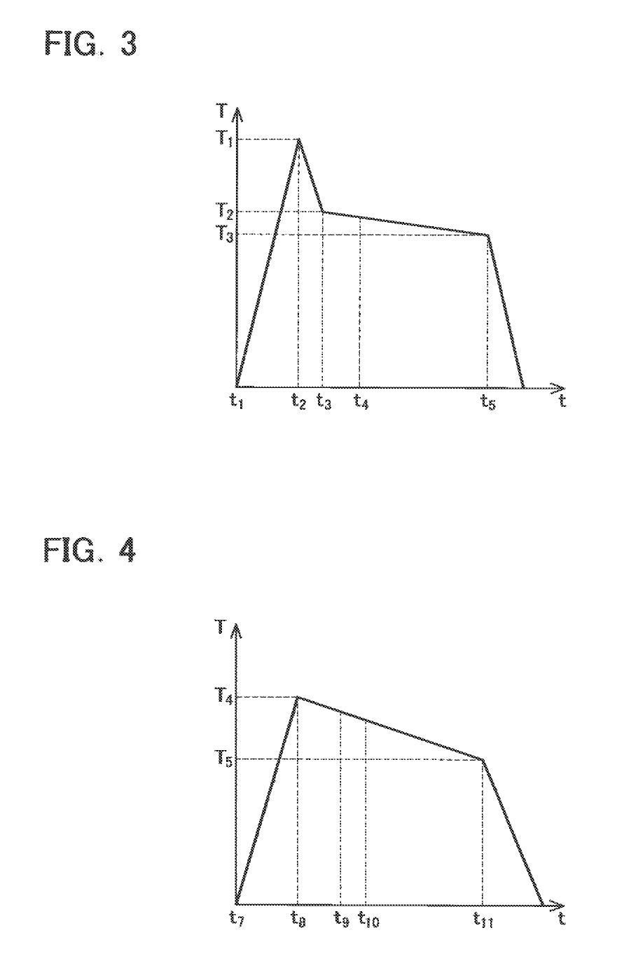

The temperature profiles shown in FIGS. 3 to 6 can be adopted, for example, as the temperature profile (heating pattern and cooling pattern) of steps S12 to S16. In the example shown in FIG. 3, first, the stabilizer bar is heated (t₁ to t₂) until the surface temperature thereof reaches T₁. Next, the stabilizer bar is cooled (t₂ to t₃) at a relatively high cooling rate (temperature decrease rate) until the surface temperature thereof becomes T₂ (the upper limit of the baking coating temperature range of the paint (T_{H} in the example of FIG. 2)); subsequently, the paint is sprayed (t₃ to t₄) onto the surface of the stabilizer bar. Once the paint is sprayed onto the surface of the stabilizer bar, the baking process is carried out (t₄ to t₅) only for a predetermined treatment time period while controlling the cooling rate such that the surface temperature of the stabilizer bar is maintained within the baking coating temperature range. The cooling rate (temperature decrease rate) of the stabilizer bar, during the time period t₃ to t₅ from the spraying of the paint onto the surface of the stabilizer bar until completion of the paint baking, is less than the cooling rate of the stabilizer bar between time t₂ to time t₃. In the temperature profile shown in FIG. 3, because the stabilizer bar is heated until the surface temperature thereof becomes T₁, which exceeds the upper limit of the baking finish temperature range, the low temperature annealing treatment effect achieved between t₁ and t₃ can be imparted more greatly. Consequently, the treatment time period t₁ to t₅ that is required for coating the surface of the stabilizer bar can be reduced.

In addition, in the example shown in FIG. 4, first, the stabilizer bar is heated (t₇ to t₈) until the surface temperature thereof reaches T₄. Next, the stabilizer bar is cooled (t₈ to t₁₁) such that the surface temperature thereof decreases at a constant cooling rate (temperature decrease rate). When the surface temperature of the stabilizer bar falls within the baking coating temperature range of the paint during this cooling, the paint is sprayed (t₉ to t₁₀) onto the surface of the stabilizer bar; subsequently, the paint sprayed onto the surface of the stabilizer bar is baked (t₁₀ to t₁₁). Similar to the example shown in FIG. 3, with the temperature profile shown in FIG. 4 as well, the treatment time period t₈ to t₁₁ required for coating the surface of the stabilizer bar can be reduced.

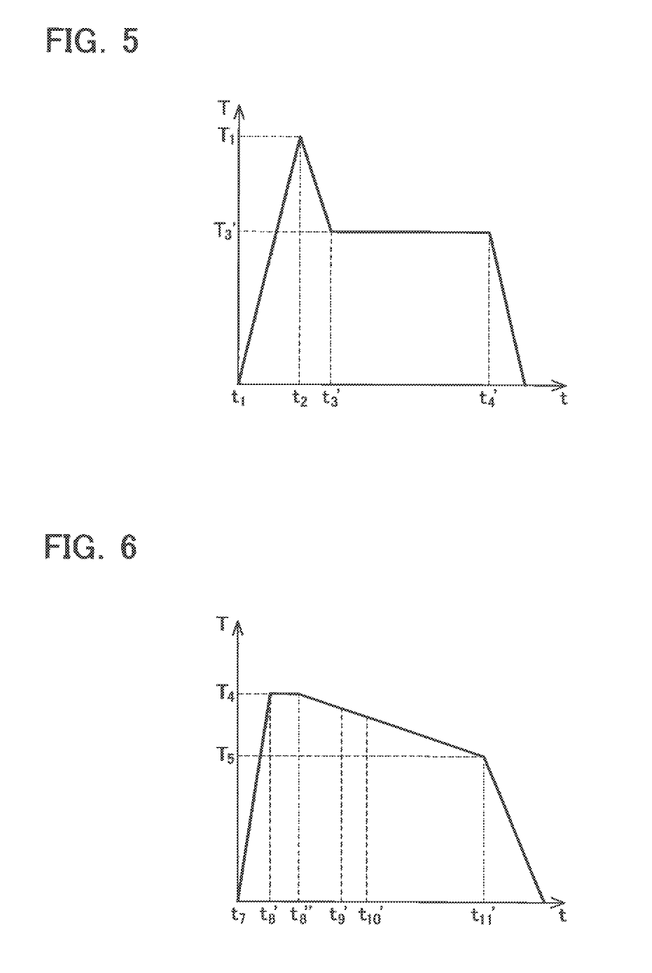

Furthermore, the temperature profile shown in the above-described FIG. 3 can be modified to obtain the temperature profile shown in FIG. 5. In the temperature profile shown in FIG. 5, unlike the temperature profile shown in FIG. 3, the cooling rate (temperature decrease rate) of the stabilizer bar during the time period t₃ to t₄ from the spraying of the paint onto the surface of the stabilizer bar until completion of the baking of the paint is set to 0 (i.e. the surface temperature of the stabilizer bar is kept constant). In such a temperature profile as well, the surface temperature of the stabilizer bar is heated up to the temperature T₁, which exceeds the upper limit of the baking coating temperature range, the treatment time period t₁ to t₄ required for coating the surface of the stabilizer bar can be reduced.

In addition, the temperature profile shown in the above-described FIG. 4 can be modified to obtain the temperature profile shown in FIG. 6. In the temperature profile shown in FIG. 6, unlike the temperature profile shown in FIG. 4, the surface temperature of the stabilizer bar is heated up to T₄ (t₇ to t_{8′}); then, the surface temperature of the stabilizer bar is kept at T₄ only for a predetermined period of time (t₈ to t_{8′}). According to such a temperature profile, the surface temperature of the stabilizer bar is made uniform and the coating quality of the stabilizer bar can be improved. Furthermore, the time period (t₈ to t_{8′}) shown in FIG. 6, which heats the surface temperature of the stabilizer bar so that it is uniform, can be provided in each of the temperature profiles of FIGS. 3 to 5.

As described in detail above, in the method for manufacturing a stabilizer bar of the present embodiment, prior to the painting, the stabilizer bar is heated up to a temperature that exceeds the upper limit of the baking coating temperature range of the paint, the paint is sprayed onto the surface of the stabilizer bar while cooling the stabilizer bar, and the sprayed paint is baked onto the surface of the stabilizer bar. Because the low temperature annealing treatment is performed on the stabilizer bar also while the stabilizer bar is heated until the temperature exceeds the upper limit of the baking coating temperature range of the paint, the low temperature annealing effect, which needs to be achieved when baking the paint, can be decreased. As a result, the treatment time period required for coating the surface of the stabilizer bar can be reduced.

The present embodiments are described above in detail, but these examples are merely illustrative and place no limitation on the scope of the patent claims. The technology described in the patent claims also encompasses various changes and modifications to the specific examples described above.

For example, in the above-described embodiments, methods for manufacturing a stabilizer bar were described; however, the technology according to the present application can be applied to methods for manufacturing a spring other than a stabilizer bar. In particular, it can be suitably applied to a spring on which a shot peening process and painting process are performed. Examples of such a spring include a coil spring and a torsion bar.

In addition, in order to achieve a uniform paint quality, the surface temperature of the spring may be measured using a thermograph and the paint may be applied to the spring, starting from the section, the surface temperature of which reaches an appropriate temperature. Unevenness in paint application can be prevented by keeping the temperature of this section constant, the section being applied with the paint first, so that an improved coating quality can be achieved.

Furthermore, it is to be understood that the technical elements described in the present specification and the drawings exhibit technical usefulness solely or in various combinations thereof and shall not be limited to the combinations described in the claims at the time of filing. The techniques illustrated in the present specification and the drawings are to achieve a plurality of objectives at the same time, and technical usefulness is exhibited by attaining any one of such objectives.

1. A method for heating treating and applying a coating to a spring, the method comprising:
heating the spring up to a predetermined temperature that exceeds an upper limit of a baking coating temperature range of the coating;
allowing a surface temperature of the spring to decrease to within the baking coating temperature range of the coating;
applying the coating to a surface of the spring, and
baking the coating onto the surface of the spring while cooling the heated spring according to a predetermined cooling function,
wherein the predetermined temperature and the predetermined cooling function are set such that a predetermined low temperature annealing effect is achieved in the spring during the heating step and the baking step.

2. The method as in claim 1, wherein the predetermined temperature is between 190 and 300° C.

3. (canceled)

4. The method as in claim 2, wherein the spring is cooled during the baking step at a cooling rate of 0.01 to 13.00° C./sec.

5. The method as in claim 4, wherein the cooling rate is 0.50 to 4.50° C./sec.

6. The method as in claim 5, further comprising:
prior to the heating step, shot peening the surface of the spring,
wherein the predetermined low temperature annealing effect is sufficient to prevent setting of the spring.

7. The method as in claim 6, wherein the coating step comprises spraying paint onto the surface of the spring.

8. The method as in claim 7, wherein the spring is a vehicle stabilizer bar having a linear part and arm parts provided at both ends of the linear part.

9. The method as in claim 8, wherein the spring is held at the predetermined temperature for a predetermined period of time prior to allowing the surface temperature of the spring to decrease.

10. The method as in claim 8, wherein the coating step begins as soon as the surface temperature of the spring has fallen to the upper limit of the baking coating temperature range.

11. The method as in claim 10, wherein the surface temperature is cooled at a faster rate prior to applying the coating than during the baking step.

12. The method as in claim 8, wherein the spring is cooled at a constant rate after reaching the predetermined temperature at least until the baking step is completed.

13. The method as in claim 8, wherein the surface temperature of the spring is maintained at a constant temperature for a portion of the baking step.

14. The method as in claim 1, further comprising:
prior to the heating step, shot peening the surface of the spring,
wherein the predetermined low temperature annealing effect is sufficient to prevent setting of the spring.

15. The method as in claim 1, wherein the spring is cooled during the baking step at a cooling rate of 0.01 to 13.00° C./sec.

16. The method as in claim 15, wherein the cooling rate is 0.50 to 4.50° C./sec.

17. The method as in claim 1, wherein the coating step comprises electrostatically applying the coating.

18. A method for simultaneously annealing and applying a coating to a spring, the method comprising:
heating the spring up to a predetermined temperature that exceeds an upper limit of a permissible baking temperature range of the coating,
allowing a surface temperature of the spring to decrease to within the permissible baking temperature range of the coating,
applying the coating to a surface of the spring, and
baking the coating onto the surface of the spring while cooling the spring for at least a portion of the baking step,
wherein the heating and baking steps together achieve a predetermined low temperature annealing effect in the spring.

19. The method as in claim 18, wherein the spring is cooled at a cooling rate of 0.50 to 4.50° C./sec during at least a portion of the baking step.

20. The method as in claim 19, wherein the predetermined temperature is between 190-300° C.

21. The method as in claim 20, further comprising:
prior to the heating step, shot peening the surface of the spring.
